(19) United States
(12) Patent Application Publication
(10) Pub. No.: US 2009/0167723 A1
(43) Pub. Date: Jul. 2, 2009

(54) Input devices

(76) Inventors: Wah Yiu Kwong, Beaverton, OR (US); Hong W. Wong, Portland, OR (US)

Correspondence Address: Caven & Aghevli LLC;c/o CPA Global, P.O. BOX 52050, MINNEAPOLIS, MN, 55402, US

(21) Appl. No.: 12/006,264

(22) Filed: Dec. 31, 2007

(51) Int. Cl. G06F 3/042; G06F 3/041

(52) U.S. Cl. 345/175; 345/173

(57) ABSTRACT

Methods and apparatus relating to input devices are described. In one embodiment, an optical or an infrared sensor may be used to detect rays focused by a lens. A touch location (e.g., associated with location of a finger, a pen, a surface contact (with a table or mouse pad, for example), etc.) may be determined based on the detected rays. Other embodiments are also disclosed.

### FIELD

The present disclosure generally relates to the field of electronics. More particularly, an embodiment of the invention generally relates to input devices.

### BACKGROUND

Portable computing devices are quickly gaining popularity in part due to their size. However, their relatively smaller form factor also limits the type of input devices that may be provided for such portable computing devices. For example, some users may choose to carry an external mouse with their laptops to improve input accuracy. This however counters the portability benefit of a portable computing device. Moreover, some current touch pads use resistive or capacitive sensing. Such implementations may however be costly to implement or provide limited accuracy. Additionally, such touch pads may be too costly for some low cost PCs (Personal Computers).

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIGS. 1A through 1D illustrate cross-sectional views of input devices, according to some embodiments.

FIGS. 2A, 2B, and 3 illustrate computing devices that may utilize the input devices discussed herein, according to some embodiments.

FIG. 4 illustrates a flow diagram of a method according to an embodiment.

FIG. 5 illustrates a block diagram of an embodiment of a computing system, which may be utilized to implement some embodiments discussed herein.

### DETAILED DESCRIPTION

In the following description, numerous specific details are set forth in order to provide a thorough understanding of various embodiments. However, various embodiments of the invention may be practiced without the specific details. In other instances, well-known methods, procedures, components, and circuits have not been described in detail so as not to obscure the particular embodiments of the invention. Further, various aspects of embodiments of the invention may be performed using various means, such as integrated semiconductor circuits (“hardware”), computer-readable instructions organized into one or more programs (“software”), or some combination of hardware and software. For the purposes of this disclosure reference to “logic” shall mean either hardware, software, or some combination thereof.

Some of the embodiments discussed herein may provide input devices that provide lower implementation costs, more accuracy, improved form factor, and/or increased ease-of-use when compared with some current input devices that rely on resistive or capacitive sensing, for example. In one embodiment, an optical or an infrared sensor may be used to detect rays focused by a lens. A touch location (e.g., associated with location of a finger, a pen, a surface contact (with a table or mouse pad, for example), etc.) may be determined based on the detected rays.

In an embodiment, a sensor may be hidden underneath the skin of a computing device chassis. This may provide additional applicability for industrial designs that may be exposed to damaging environmental factors such as heat, moisture, shock, etc. In various embodiments, the sensors used may be optical or infrared (IR) sensors. Further, the input devices discussed herein may have no moving parts and may be arranged into different shapes, e.g., to provide a reduced form factor. In an embodiment, a single input device may be used as a touch pad, an external mouse, or a pointing device (e.g., a remote pointing device used for a presentation). Such a device may utilize the same software and/or hardware for its various usage models, e.g., to lower manufacturing and implementation costs.

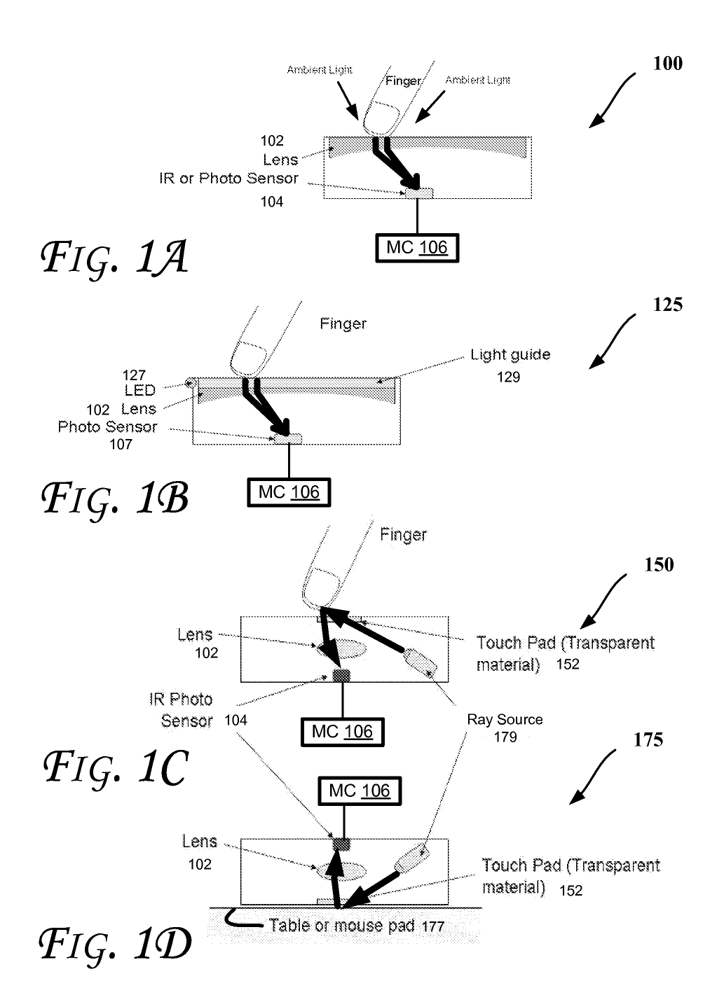

FIG. 1A illustrates a cross-sectional view of an input device 100, according to an embodiment. The input device 100 may include a lens 102 that may focus optical rays incident on the lens 102 (such as the ambient light shown in FIG. 1) towards an IR or photo sensor 104. The lens 102 may have any shape, which is capable of focusing light rays towards the sensor 104. In an embodiment, the sensor 104 may be an array of CMOS (Complementary Metal-Oxide Semiconductor) photo or IR pixels. The number of pixels for the senor 104 is flexible and may depend on the design and/or cost goals. In one embodiment, the array may be a 16×16 pixel array. In one embodiment, the device 100 may be capable of operating in low ambient light, e.g., by using an IR type sensor for the sensor 104.

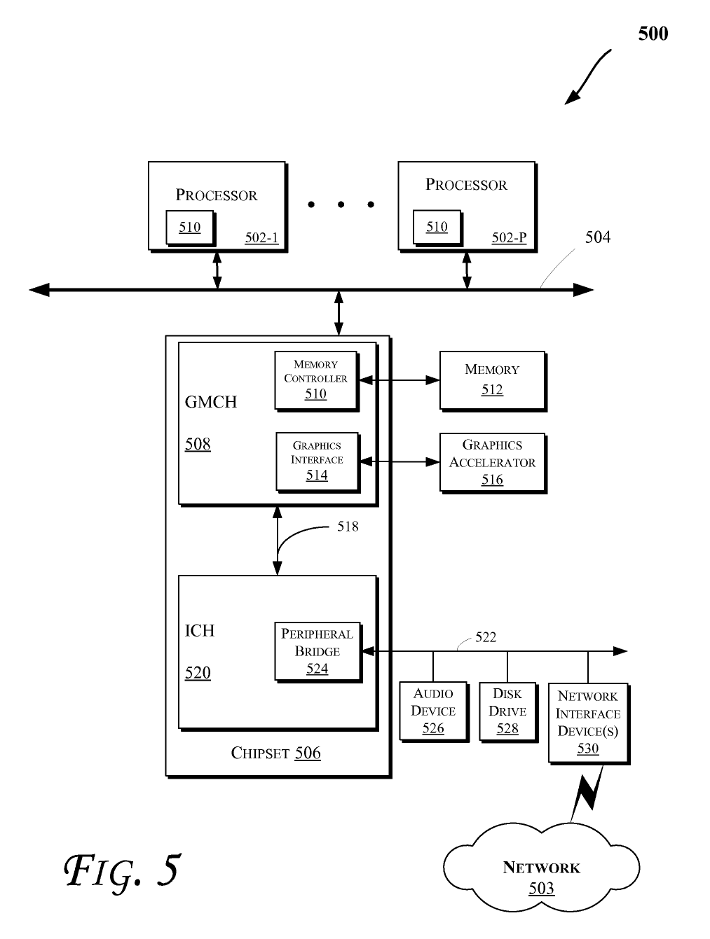

As shown in FIG. 1A, a micro-controller (MC) 106 may be coupled to the sensor 104 to receive sensed signal and determine touch locations (e.g., associated with locations of a finger, a pen, a surface contact, etc.) and/or gestures and communicate the information to other components of a computing device such as those discussed with reference to FIG. 5. Moreover, the micro-controller 106 may be responsible for managing and collecting the photo or IR sensors measurements, compensating for environmental effects such as electrical noise and temperature drift, computing the position and proximity of the pen or finger, detecting motion and tapping gestures, and/or communicating with the host system using mouse-compatible or other protocols. In some embodiments, various sensors (not shown) may be coupled to the MC 106 to provide information regarding environmental factors. Additionally, the micro-controller 106 may have access to memory to store data, e.g., including data corresponding to the signals received from the sensor 104 and/or information regarding touch locations and/or gestures. Various types of memory devices may be used including for example those memory device types discussed with reference to FIG. 5. Also, even though some figures herein show a single sensor, more than one sensor may be used in some embodiments.

FIG. 1B illustrates a cross-sectional view of an input device 125, according to an embodiment. In one embodiment, the lens 102, sensor 107, and the MC 106 shown in FIG. 1B may be the same as or similar to those discussed with reference to FIG. 1A. As shown, the sensor 107 may be a photo sensor in one embodiment. Also, the device 125 may further include an LED (Light Emitting Diode) 127 (or another light source) to provide a light guide 129. In an embodiment, the combination of the LED 127 and the light guide 129 may allow the sensor 107 to detect input information more accurately in low ambient light situations, even when using a photo sensor.

In some embodiments, a translucent plastic sheet may be provided over the lens 102 (not shown), e.g., to protect the lens 102 more to improve user touch experience. Alternatively, the plastic sheet may be integrated with lens 102, e.g., to reduce the overall module part count. Also, the lens 102 may be constructed with any translucent material such as glass or plastic. Accordingly, in some embodiments (such as those discussed with reference to FIGS. 1A-3), a sheet of translucent plastic sheet and a lens subsystem is overlaid on top of a lower resolution (e.g., 16×16 pixels) optical sensor array. The sensor array may be the one used for an optical mouse. A finger, upon touching the plastic sheet or lens may cast a shadow onto the sensor array, e.g., relative to ambient light or other sources of light discussed herein. The information from the sensor array may then be passed to the micro-controller 106 for processing in form of signals. In the case of designs using an IR sensor, the thermal difference of the finger and other parts of the module may allow the micro-controller 106 to detect the location and movement of the finger and then translate such information into input data.

In some embodiments, the photo or IR sensor 104/107 takes successive pictures of the surface (e.g., of the lens 102 or protective cover) where the user places the input device (e.g., in the mouse mode of input device operation) or where the user moves its finger (e.g., in the touchpad mode of input device operation). Changes between one frame and the next are processed by the image processing techniques (e.g., provided through the micro-controller 106) and translated (e.g., by the MC 106) into movement on two axes, for example, using an optical flow estimation algorithm. Such information may be converted in PS2 (Personal System 2) or similar standard protocols for mouse input in some embodiments.

FIG. 1C illustrates a cross-sectional view of an input device 150, according to an embodiment. In one embodiment, the lens 102 (now disposed between a touch pad 152 and the sensor 104 such as shown in FIG. 1C), sensor 104, and the MC 106 shown in FIG. 1A or 1B may be the same as or similar to those discussed with reference to FIG. 1C. As shown, the sensor 104 may be a photo or an IR sensor in some embodiments. Also, the device 150 may further include a touchpad 152 (e.g., constructed with transparent material), which comes into contact with a user's finger or a pen for example.

FIG. 1D illustrates a cross-sectional view of an input device 175, according to an embodiment. In one embodiment, the lens 102 (now disposed between a touch pad 152 and the sensor 104 such as shown in FIG. 1D), sensor 104, the MC 106, and/or touchpad 152 shown in FIG. 1A, 1B, or 1C may be the same as or similar to those discussed with reference to FIG. 1D. As shown, the touch the 152 of FIG. 1D may come in contact with a stationary object 177, such as a table or mouse pad. Accordingly, device 175 may be used as a mouse in one embodiment, as will be further discussed with reference to FIG. 3. Also, as shown in FIGS. 1C and 1D, a ray source 179 (such as a visible light source or an IR emitter) may be used to generate rays that are bounced off of a user's finger (or another object such as a pen) or the stationary object 177, respectively, prior to being focused by the lens 102 onto the sensors 104.

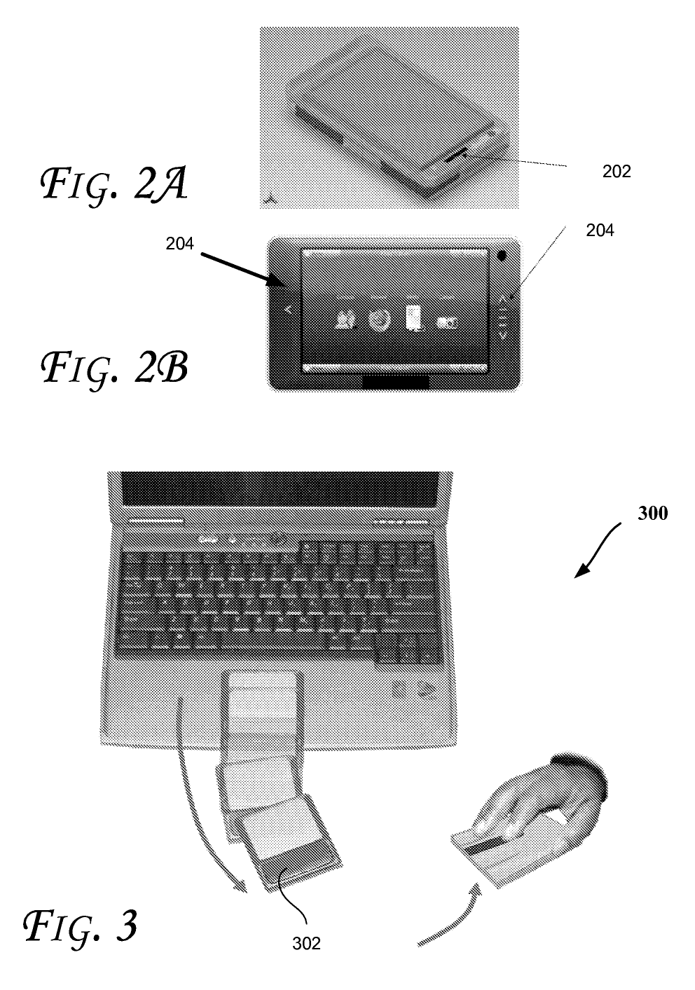

FIGS. 2A and 2B illustrate portable computing devices that may utilize the input devices discussed with reference to FIGS. 1A-1D, according to some embodiments. For example, a touchpad or scroll bar 202 may be used for a personal digital assistant (PDA) such as shown in FIG. 2A. Further, FIG. 2B illustrates flexibility in designing the sensors to meet industrial requirements. For example, with an IR sensor array (such as discussed with reference to FIGS. 1A-1D), the array may be arranged in different shape, which may be placed at the underside of the housing. This allows the flexibility of the industrial design without requiring a fixed shape and size of the window for touch pad input devices (e.g., touch devices 204 shown in FIG. 2B).

In an embodiment, a sensor (such as those discussed herein, e.g., with reference to FIGS. 1A-1D) may be hidden underneath the skin of a computing device chassis (such as shown in FIG. 2B, for example). This may provide additional freedom for industrial designs that may be exposed to damaging environmental factors such as heat, moisture, shock, etc. Such an embodiment may reduce (or eliminate) the need for a separate covering piece for the sensor and, as a result, reduce the assembly part count, hence the cost of the implementation.

FIG. 3 illustrates that an input device 302 (which may be the same or similar to those discussed with reference to FIGS. 1A-2B) may be decoupled from a portable computing device (such as a laptop as shown in FIG. 3) and used as a mouse, a pointing device, or a touch pad, in accordance with some embodiments. Furthermore, the input device 302 may be integrated into a portable computing device (such as a laptop as shown in FIG. 3) to eliminate the need for a user to carry an external device (such as an external mouse or touchpad). In some embodiments, no moving parts may provide a more reliable and/or low assembly solution. The integration of various types of input devices into a single device may also enhance the portability of the overall system, e.g., as a user does not need to carry multiple devices to achieve the same goals.

In some embodiments, the input devices discussed herein may also include a three dimensional (3D) accelerometer. The accelerometer may be used for a remote pointing device implementation. For example, a user may just need to move the input device and point to the power point presentation on a screen. Also, in an embodiment, a wireless radio (such as a Bluetooth radio) may also be included with the input devices discussed herein. The wireless radio may transmit signals to a host computer which may then be used to determine the location of the input device, e.g., as may be used for the pointing device implementation. Further, the input devices discussed herein may also include the source of power (such as a battery) to support operations of various logic included with input devices (such as the sensors 104/107, ray source 179, MC 106, etc.).

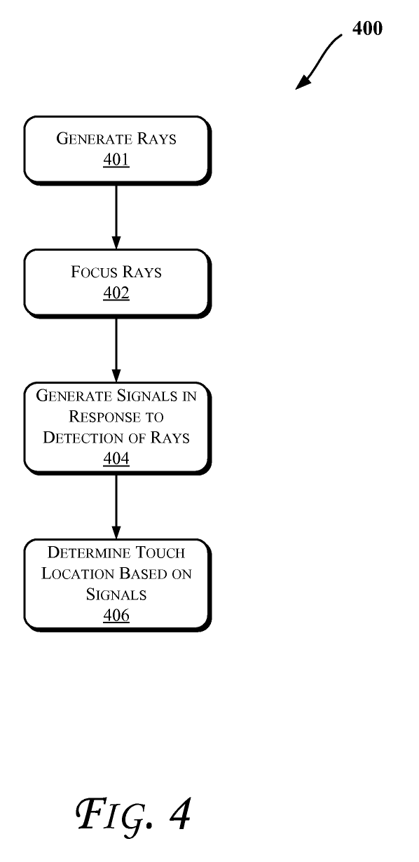

FIG. 4 illustrates a flow diagram of a method 400 to determine the location of a touch, according to one embodiment. Various components discuss herein with reference to FIGS. 1A-3 and 5 may be utilized to perform one or more of the operations of FIG. 4.

Referring to FIGS. 1A-4, at an operation 401, raise may be generated (e.g., LED 127 and/or ray source 179 discussed with reference to FIGS. 1B and 1C-1D, respectively). At an operation 402, the generated rays may be focused (e.g., by the lens 102). At an operation 404, signals may be generated in response to detection of the rays (e.g., by the sensors 104 and/or 107). At an operation 406, the location of a touch (which may be used as a mouse or touchpad input or used to determine movement or a gesture, etc. in various embodiments) may be determined (e.g., by the MC 106) based on the signals of operation 404.

As discussed with reference to FIGS. 1A-4, the input devices discussed herein may be used to provide input data to a host computing device, which may be a portable computing device in an embodiment such as a PDA, a cell phone, a digital camera, an ultra-mobile personal computer (UMPC), etc. More particularly, FIG. 5 illustrates a block diagram of a computing system 500 in accordance with an embodiment of the invention. The computing system 500 may include one or more central processing unit(s) (CPUs) or processors 502-1 through 502-P (which may be referred to herein as “processors 502” or “processor 502”). The processors 502 may communicate via an interconnection network (or bus) 504. The processors 502 may include a general purpose processor, a network processor (that processes data communicated over a computer network 503), or other types of a processor (including a reduced instruction set computer (RISC) processor or a complex instruction set computer (CISC)). Moreover, the processors 502 may have a single or multiple core design. The processors 502 with a multiple core design may integrate different types of processor cores on the same integrated circuit (IC) die. Also, the processors 502 with a multiple core design may be implemented as symmetrical or asymmetrical multiprocessors. In an embodiment, the operations discussed with reference to FIGS. 1A-4 may be performed by one or more components of the system 500. Also, the input devices discussed herein may provide input data to the computing system 500.

A chipset 506 may also communicate with the interconnection network 504. The chipset 506 may include a graphics memory control hub (GMCH) 508. The GMCH 508 may include a memory controller 510 that communicates with a memory 512. The memory 512 may store data, including sequences of instructions that are executed by the processor 502, or any other device included in the computing system 500. In one embodiment of the invention, the memory 512 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk. Additional devices may communicate via the interconnection network 504, such as multiple CPUs and/or multiple system memories.

The GMCH 508 may also include a graphics interface 514 that communicates with a graphics accelerator 516. In one embodiment of the invention, the graphics interface 514 may communicate with the graphics accelerator 516 via an accelerated graphics port (AGP). In an embodiment of the invention, a display (such as a flat panel display, a cathode ray tube (CRT), a projection screen, etc.) may communicate with the graphics interface 514 through, for example, a signal converter that translates a digital representation of an image stored in a storage device such as video memory or system memory into display signals that are interpreted and displayed by the display. The display signals produced by the display device may pass through various control devices before being interpreted by and subsequently displayed on the display.

A hub interface 518 may allow the GMCH 508 and an input/output control hub (ICH) 520 to communicate. The ICH 520 may provide an interface to I/O devices that communicate with the computing system 500. The ICH 520 may communicate with a bus 522 through a peripheral bridge (or controller) 524, such as a peripheral component interconnect (PCI) bridge, a universal serial bus (USB) controller, or other types of peripheral bridges or controllers. The bridge 524 may provide a data path between the processor 502 and peripheral devices. Other types of topologies may be utilized. Also, multiple buses may communicate with the ICH 520, e.g., through multiple bridges or controllers. Moreover, other peripherals in communication with the ICH 520 may include, in various embodiments of the invention, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 522 may communicate with an audio device 526, one or more disk drive(s) 528, and one or more network interface device(s) 530 (which is in communication with the computer network 503). Other devices may communicate via the bus 522. Also, various components (such as the network interface device 530) may communicate with the GMCH 508 in some embodiments of the invention. In addition, the processor 502 and other components shown in FIG. 5 (including but not limited to the GMCH 508, one or more components of the GMCH 508 such as the memory controller 510, etc.) may be combined to form a single chip. Furthermore, a graphics accelerator may be included within the GMCH 508 in some embodiments of the invention.

Furthermore, the computing system 500 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 528), a floppy disk, a compact disk ROM (CD-ROM), a digital versatile disk (DVD), flash memory, a magneto-optical disk, or other types of nonvolatile machine-readable media that are capable of storing electronic data (e.g., including instructions). In an embodiment, components of the system 500 may be arranged in a point-to-point (PtP) configuration. For example, processors, memory, and/or input/output devices may be interconnected by a number of point-to-point interfaces.

In various embodiments of the invention, the operations discussed herein, e.g., with reference to FIGS. 1A-5, may be implemented as hardware (e.g., logic circuitry), software, firmware, or any combinations thereof, which may be provided as a computer program product, e.g., including a machine-readable or computer-readable medium having stored thereon instructions (or software procedures) used to program a computer (e.g., including a processor) to perform a process discussed herein. The machine-readable medium may include a storage device such as those discussed with respect to FIG. 1 or 5.

Additionally, such computer-readable media may be downloaded as a computer program product, wherein the program may be transferred from a remote computer (e.g., a server) to a requesting computer (e.g., a client) by way of data signals embodied in a carrier wave or other propagation medium via a communication link (e.g., a bus, a modem, or a network connection).

Reference in the specification to “one embodiment” or “an embodiment” means that a particular feature, structure, and/or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments of the invention, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments of the invention have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. An input device comprising:
a lens to focus rays incident on a sensor;
the sensor to generate signals in response to detection of the focused rays; and
a logic coupled to the sensor to receive the generated signals from the sensor and to determine, based on the received signals, a location of a touch on a side of the lens that faces away from the sensor.

2. The device of claim 1, further comprising a Light Emitting Diode (LED) to illuminate a light guide, wherein the lens is disposed between the light guide and the sensor.

3. The device of claim 2, wherein the sensor comprises an optical sensor.

4. The device of claim 1, further comprising a protective cover disposed between the lens and an outside environment.

5. The device of claim 1, wherein the sensor comprises an infrared (IR) sensor or an optical sensor.

6. The device of claim 1, wherein the sensor comprises a 16×16 pixel sensor array.

7. The device of claim 1, further comprising a memory coupled to the logic to store data.

8. The device of claim 1, wherein the lens is constructed with material selected from a group consisting of plastic and glass.

9. The device of claim 1, wherein the touch location corresponds to a location of one or more of: a finger, a pen, or a surface contact.

10. The device of claim 1, wherein the sensor is hidden underneath a skin of a computing device chassis.

11. A method comprising:
focusing rays incident on a sensor;
generating signals in response to detection of the focused rays; and
determining, based on the received signals, a location of a touch on a side of the lens that faces away from the sensor.

12. The method of claim 11, further comprising illuminating a light guide to generate at least a portion of the rays incident on the sensor.

13. The method of claim 11, further comprising the sensor detecting infrared (IR) rays or optical rays.

14. The method of claim 11, further comprising storing data in a memory.

15. The method of claim 11, further comprising blocking at least a portion of the rays with a skin of a computing device chassis.
